(19) United States
(12) Patent Application Publication
(10) Pub. No.: US 2008/0313620 A1
(43) Pub. Date: Dec. 18, 2008

(54) SYSTEM AND METHOD FOR SAVING AND RESTORING A SELF-DESCRIBING DATA STRUCTURE IN VARIOUS FORMATS

(75) Inventor: Andrew OLIVER, West Hills, CA (US)

Correspondence Address: FOLEY AND LARDNER LLP;SUITE 500, 3000 K STREET NW, WASHINGTON, DC, 20007, US

(73) Assignee: Spirent Communications, Inc.

(21) Appl. No.: 12/138,040

(22) Filed: Jun. 12, 2008

Related U.S. Application Data
(60) Provisional application No. 60/944,428, filed on Jun. 15, 2007.

(51) Int. Cl. G06F 9/45

(52) U.S. Cl. 717/151

(57) ABSTRACT

A system and method for saving and/or restoring a self-describing data structure in various formats is provided. The method includes the steps of executing a data structure engine and an export/import module in a computer system; said export/import module obtaining at least one description set for at least one container data structure from said data structure engine; creating a header for each element in the data structure; declaring the structure by writing its type in a format-specific syntax; outputting each property in the structure and outputting child structures to form an external representation of the self-describing data structure.

### CROSS-REFERENCE TO RELATED PATENT APPLICATIONS

This application claims the benefit of U.S. Provisional Patent Application No. 60/944,428, filed Jun. 15, 2007, which incorporates in its entirety U.S. Pat. No. 7,143,101, both of which are herein incorporated by reference in their entirety.

### FIELD OF INVENTION

The present invention is related to the field of software applications. Specifically, the present invention is directed to providing a method and apparatus for building computer programs applications utilizing self-describing externally defined container data structures and saving and restoring the self-describing data structures in various formats.

### BACKGROUND

The following description of the background of the invention is provided simply as an aid in understanding the invention and is not admitted to describe or constitute prior art to the invention.

In a typical computer program, the architecture of the in-memory data representation is provided within the binary code (or bytecode) which a compiler produces by compiling the program's source code. Modern programs are almost all written in a high level programming language. A variety of languages exist, and allow programmers to write code in a human-friendly syntax. Examples of programming languages are JAVA, C/C++, PASCAL, FORTRAN, ADA, etc. A high level language essentially provides an easy to read and write syntax for describing computing operations. Furthermore, some high level languages (e.g., C++ and JAVA) may implement object oriented concepts such as the concept of objects itself, the concept of inheritance, etc. Object oriented concepts allow programmers to design better data storage architectures, and implement code that is easy to manipulate and reuse.

Every high-level based source code has to be compiled with a compiler. A compiler analyzes the source code and generates executable code that computers are able to execute. However, not every high-level programming language is destined to be executed directly by a machine. For example, the JAVA programming language may be compiled into bytecode that is then run by a JAVA virtual machine, which is a computer program capable of translation bytecode into machine specific execution instructions. Other high-level programming languages are designed to be interpreted at run time. For example, the PERL and SHELL provide scripting languages. The programs are interpreted at run time by an interpreter.

Whether a programming language is destined to be compiled, translated or interpreted, the steps for declaring data architecture and creating associating computing operations with the data almost always follows the same path: the programmer inputs all the definitions of the data and the association with operations in the source code, and the high-level instructions are translated into computer executable instructions. For example, a variable may be declared with a name and a type in the source. The compiler reads the variable declaration in the source code and generates executable code that reserves a memory space of a predetermined size, and executable code for generating the memory location address. The size of the memory allocated during execution is determined by one or both of two factors. First, the programming language may have a standard definition of the basic data types, and second the data size may depend on the hardware architecture of each platform. Hence, integers that may be represented by sixteen (16) bits (two bytes) on one hardware platform and by thirty two (32) bits (four bytes) on a different hardware architecture.

Data declarations in computer programs typically define variable names their type and sometimes their positions in relation to each other. Several concepts are implemented in existing high-level programming languages. At the basic level, a data structure may include a simple variable (e.g., an integer) implemented through a name and a size, or through a complex description of data entities. Examples of higher-level data descriptions include arrays, data structures and objects. Arrays are ensembles of equally sized memory spaces represented in the computer memory by a contiguous space of memory where each location can be addressed individually or using an offset from the beginning of the array using one or multiple dimensions schemes. Complex data structures contain data of different sizes, each of which may be addressed using an offset from the beginning of the data structure using pointers. Objects typically include data declarations and code for manipulating the data.

In existing programming schemes, a computer application must always include the definition declarations of the data in the source code in order to be included in the binary code. The obvious shortcoming of this approach is that the architecture of data structures may not be changed in the executable code. If a change is to be applied to the structure of the data, the source code has to be modified, and compiled de novo to generate executable code capable of representing the data.

Therefore, there is a need for a method that allows data manipulation in computer programs without involving the process of generating the executable code. Further, there is a need for generating and storing the data in various formats.

### SUMMARY

According to one embodiment, a method for constructing an alternate representation of a self-describing data structure, comprises executing a data structure engine and an export/import module in a computer system; said export/import module obtaining at least one description set for at least one container data structure from said data structure engine; creating a header for each element in the container data structure; declaring the container data structure by writing its type in a format-specific syntax; outputting each property in the container data structure and outputting child structures to form an external representation of the self-describing data structure.

According to another embodiment, a method for constructing a XML file from a self-describing data structure, comprises executing a data structure engine and an export/import module in a computer system; said export/import module obtaining at least one description set for at least one container data structure from said data structure engine; saving the topmost data structure in the hierarchy of the container data structure; creating an XML element per object in the container data structure; creating XML attributes for the properties of each object in the container data structure; determining a list of child objects from the container data structure; nesting each XML element in a parent XML element corresponding to the child objects and storing relationships from the container data structure as relation elements to form an XML file representation of the self-describing data structure.

According to yet another embodiment, a method for constructing a Tcl script file from a self-describing data structure, comprises executing a data structure engine and an export/import module in a computer system; said export/import module obtaining at least one description set for at least one container data structure from said data structure engine; creating objects using class names acquired from the container data structure; setting the attributes of the objects; storing returned object handles as uniquely named variables and configuring relationships between the objects using a relationship type name acquired from the data model to form a Tcl script representing the self-describing data structure.

According to still another embodiment, a method for constructing a HTML file from a self-describing data structure, comprises executing a data structure engine and an export/import module in a computer system; said export/import module obtaining at least one description set for at least one container data structure from said data structure engine; creating an HTML header per object in the container data structure; nesting unordered lists to create a tree corresponding to a parent/child relationship in the container data structure and creating one HTML table for the properties in each object in the container data structure to form a HTML file representing the self-describing data structure.

According to another embodiment, a method of importing an XML file into a self-describing data structure, comprises creating one data structure object for each XML element; setting the properties of the data structure for each corresponding XML element using the XML attribute name as the property name and the XML attribute value as the property value; adding a data structure object for each nested XML element as a child of a previously-created data structure object corresponding to the enclosing XML element and constructing relationships in the data structure based on Relation sub-elements for the data structure.

It is to be understood that both the foregoing general description and the following detailed description are exemplary and explanatory only, and are not restrictive of the invention as claimed.

### BRIEF DESCRIPTION OF THE DRAWINGS

Features, aspects and advantages of the present invention will become apparent from the following description, appended claims, and the accompanying exemplary embodiments shown in the drawings, which are briefly described below.

FIG. 1 is a block diagram representing overall software architecture in accordance with one or more embodiments of the invention.

FIG. 2 is a flowchart illustrating steps involved in utilizing container data structures in accordance with embodiments of the invention.

FIG. 3 is a flowchart illustrating steps involved in loading and handling data input and output request in applications embodying the invention.

FIG. 4 is a flowchart illustrating the steps involved in exporting a self-describing data structure.

FIG. 5 is a flowchart illustrating the steps involved in exporting a self-describing data structure in an XML format.

FIG. 6 is a flowchart illustrating the steps involved in exporting a self-describing data structure in a Tcl file format.

FIG. 7 is a flowchart illustrating the steps involved in exporting a self-describing data structure in a HTML format.

FIG. 8 is a flowchart illustrating the steps involved in importing a self-describing data structure from an XML file.

### DETAILED DESCRIPTION

Embodiments of the present invention will be described below with reference to the accompanying drawings. It should be understood that the following description is intended to describe exemplary embodiments of the invention, and not to limit the invention.

The invention discloses a method and apparatus for providing and saving externally-defined container data structures. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

Throughout the following disclosure, the reference to a user is alternately used to refer to a person using a computer application and/or to one or more automatic processes.

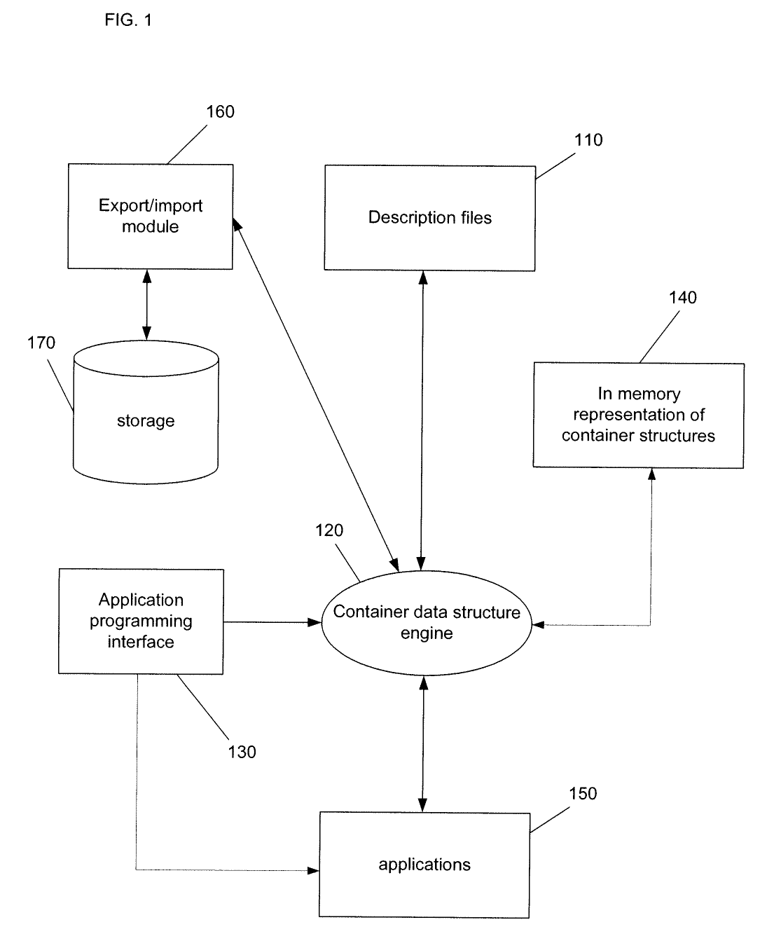

FIG. 1 is a block diagram representing overall software architecture in accordance with one or more embodiments of the invention. In embodiments of the invention, description files 110 comprise one or more data sources. A data source may be a flat file, a relational database system, a network data stream or any other means allowing a computing system to obtain data. A description file contains descriptions of one or more container data structures. A container data structure refers to a data entity (e.g. data structure) that contains all the information about the data entity allowing a system implementing the invention to build an in-memory representation of the data structure, and implement functionality to control data handling processes.

Embodiments of the invention implement a container data structure engine 120. The container data structure engine 120 provides a set of tools that allow one or more applications 150 to create an in-memory representation of data 140. Embodiments of the invention also provide an application programming interface 130 which the application and the engine implement to provide the capability to load description files, create the in-memory representation of the data and handle the data input and output transactions.

The description files 110 contain a self-describing hierarchical data structure that provides information about properties for each data structure and each level of the hierarchy. Such a structure holds properties and descriptions of other structures. In embodiments of the invention, a property is comprised of a name and value. Each structure and its subsidiary structures form a tree of structures. The tree contains a root structure which contains, directly or indirectly, all other structures in the tree. Thus, given only a reference to the root structure in such a tree, all other structures can be reached, and all properties contained in those structures can be found and their values inspected. In the present disclosure, the term “schema” is used to refer to the description of structures contents and relationships. The description may be defined in external data files.

An export/import module 160 is configured to construct an external representation of a self-describing data structure contained in the description files 110. The export/import module 160 can export the self-describing data structures into various formats including a Tcl Script, an XML file and an HTML file. According to another embodiment, the export/import module 160 can import an XML file into the description files 110. According to one embodiment, the external representation is constructed recursively by descending through the self-describing data structure. The export/import module 160 wraps each property and structure in the self-describing data structure in format-specific syntax or commands and writes them to a file or other external storage location 170. According to one embodiment, the format may be any format capable of grouping elements, storing name/value pairs and establishing relationships between elements.

In embodiments of the invention, the self-describing container data structures contain properties and other structures. Properties may be in the form of name/value pairs, for example. Each property has a type that defines whether it is numeric, text or any other type defined in one or more standard definitions or custom built. Properties may describe a variety of attributes associated with the data. For example, properties may describe range limits of numerical values, maxima and minima or any other data property. Furthermore, every datum may have a fixed number of allowed values. Structures that are defined by a schema may have a fixed list of properties given in the schema.

In embodiments of the invention, the approach to building container data structures is extensible: new structure types and their relationships can be supported without changes to the interface or implementation. The interface allows all data structure manipulations, including construction and assignment provided in the schema.

In embodiments of the invention, the schema defines hierarchy constraints such as which structures may be allowed to be children of other which other structures, and the number of structures of a specified type in each sub-structure. For example, structures that contain other structures are built under the constraints defined in the schema.
Structure definitions comprise:
Structure name
Properties contained in the structure
Relationships to other structures
Property definitions comprised
Property name
Property type
Default Values Optionally, either List of allowed values or Minimum/Maximum values

Property names, values, and limits can be inspected at runtime. The Application Programming Interface 130 provides functions that allow the list of property names to be retrieved. For each property name, another function allows the value of the property to be retrieved. Each property may also be associated with one or more attributes defining the mechanisms for accessing the data in the structure at runtime. For example, the attributes may define how the engine is to handle broadcasting and/or hiding the values of a given property.

Embodiments of the invention provide the capability to determine the child to parent relationships in hierarchical structures at runtime. One or more functions in the Application Programming Interface allow for building and inspecting hierarchical structures.

The descriptions of the container data structures and their hierarchical relationships are interpreted to create the in-memory representations of data structures that support applications embodying the invention.

According to one embodiment, Extensible Markup Language (XML) standard can be used to build description files. As a guide, aspects of the Extensible Markup Language are provided below:

Extensible Markup Language (XML) is a human-readable, machine-understandable, general syntax for describing hierarchical data. XML is an open standard for describing data developed under the auspices by the World Wide Web Consortium (W3C). XML is a subset of the Standard Generalized Markup Language (SGML) defined in ISO standard 8879:1986. XML is a formal language that can be used to pass information about the component parts of a document from one computer system to another. XML is used to describe any logical text structure (e.g. form, book, database etc.). XML is based on the concept of documents composed of a series of entities. Each entity can contain one or more logical elements. Each of these elements can have certain attributes (properties) that describe the way in which it is to be processed. XML also provides a formal syntax for describing the relationships between the entities, elements and attributes that make up an XML document, such a syntax can be used to recognize component parts of each document.

XML differs from other markup languages in that it does not simply indicate where a change of appearance occurs, or where a new element starts. XML clearly identifies the boundaries of every part of a document, (e.g., whether a text block is new chapter, or a reference to another publication). XML uses custom tags enabling applications to define, transmit, validate and interpret data shared between applications and between organizations.

To allow a computer to check the structure of a document, users must provide it with a document type definition that declares each of the permitted entities, elements and attributes, and the relationships between them. By defining the role of each element of text in a formal model, known as a Document Type Definition (DTD), users of XML can check that each component of document occurs in a valid place within the interchanged data stream. An XML DTD allows computers to check, for example, that users do not accidentally enter a third-level heading without first having entered a second-level heading, something that cannot be checked using the HyperText Markup Language (HTML) previously used to code documents that form part of the World Wide Web (WWW) of documents accessible through the Internet. However, XML does not restrict users to using DTDs.

To use a set of markup tags that has been defined by a trade association or similar body, users need to know how the markup tags are delimited from normal text and in which order the various elements should be used. Systems that understand XML can provide users with lists of the elements that are valid at each point in the document, and will automatically add the required delimiters to the name to produce a markup tag. Where the data capture system does not understand XML, users can enter the XML tags manually for later validation. Elements and their attributes are entered between matched pairs of angle brackets (< . . . >) while entity references start with an ampersand and end with a semicolon (& . . . ;).

Because XML tag sets are based on the logical structure of the document they are somewhat easier to understand than physically based markup schemes of the type typically provided by word processors. As an example, a memorandum coded in XML might look as follows:

<memo>
<to>All staff</to>
<from>R. Michael</from>
<date>April 1, 2001</date>
<subject>Power Saving</subject>
<text>Please turn off your desktops before you leave.</text>
</memo>

As shown in the example above, the start and end of each logical element of the file has been clearly identified by entry of a start-tag (e.g. <to >) and an end-tag (e.g. </to >). This formatting is ideal for a computer to follow, and therefore for data processing.

To define tag sets users may create a Document Type Definition that formally identifies the relationships between the various elements that form their documents. For the simple memorandum example, the XML DTD might take the form:

<!DOCTYPE memo [
<!ELEMENT memo (to, from, date, subject?, para+) >
<!ELEMENT para (#PCDATA) >
<!ELEMENT to (#PCDATA) >
<!ELEMENT from (#PCDATA) >
<!ELEMENT date (#PCDATA) >
<!ELEMENT subject (#PCDATA) >
]>

This model indicates that a memorandum consists of a sequence of header elements, <to >, <from>, <date> and, optionally, <subject>, which must be followed by the contents of the memorandum. The content of the memo defined in this simple example is made up of a number of paragraphs, at least one of which must be present (this is indicated by the + immediately after para). In this simplified example, a paragraph has been defined as a leaf node that can contain parsed character data (#PCDATA), i.e., data that has been checked to ensure that it contains no unrecognized markup strings.

XML-coded files are suitable for communicating data to be stored in databases. Because XML files are both object-orientated and hierarchical in nature, they can be adapted to many types of databases. A standardized interface to XML data is defined through W3C's Document Object Model (DOM), which provides a Common Object Request Broker Architecture (CORBA) interface definition language (IDL) interface between applications exchanging XML data.

XML validation and well formedness can be checked using XML processors to which it is commonly referred as XML parsers. An XML processor parser checks whether an XML document is valid by checking that all components are present, and the document instance conforms to the rules defined in the DTD. An up-to-date version of the XML/DTD is available on the World Wide Web Consortium web site URL<http://www.w3.org>.

The following XML code is provided with the following explanations to illustrate a schema as utilized according to one embodiment.

```
<?xml version=“1.0” encoding=“UTF-8”?>
<!ELEMENT Schema (SchemaType+, StructureTemplate*)>
<!ATTLIST Schema name CDATA #REQUIRED windowed
(true|false) “false”>
<!ELEMENT SchemaType EMPTY>
<!ATTLIST SchemaType name (Current|Persistent|Requested)
“Persistent”>
<!ELEMENT StructureTemplate (StructureName,
    Description?, PrimaryKey, Property*, Relation*,
    StructureRef*, StructureTemplate*)>
<!ATTLIST StructureTemplate parentRelationType CDATA “NULL”
    command (true|false) “false” buckets CDATA “1”>
<!ELEMENT StructureName (#PCDATA)>
<!ATTLIST StructureName schemaName CDATA #IMPLIED>
<!ELEMENT SchemaName (#PCDATA)>
<!ELEMENT PrimaryKey (Property)>
<!ELEMENT Relation (ForeignKey | ForeignKeyTemplate)+ >
<!ATTLIST Relation name CDATA
    #REQUIRED cardinality (one-to-one| many-to-one|zero-one-
    to-one| zero-many-to-one) “one-to-one” direction (up|down)
    “up” maximum CDATA #IMPLIED defaultChildCount
    CDATA “0”> <!ELEMENT StructureRef (StructureName)>
<!ELEMENT ForeignKey (StructureName)>
<!ELEMENT ForeignKeyTemplate (StructureNameTemplate)>
<!ATTLIST ForeignKeyTemplate relationType CDATA #REQUIRED>
<!ELEMENT StructureNameTemplate EMPTY >
<!ATTLIST StructureNameTemplate name CDATA #IMPLIED>
<!ELEMENT PropertyTemplate EMPTY >
<!ATTLIST PropertyTemplate name CDATA #IMPLIED
    type CDATA #IMPLIED
    count CDATA #IMPLIED
    visible CDATA #IMPLIED>
<!ELEMENT Property (Description?,
EnumeratedValue*, MinValue?, MaxValue?,
    ForcedValue?, DefaultValue?)> <!ATTLIST Property name
    CDATA #REQUIRED type CDATA #REQUIRED count
    CDATA “1” visible (true|false) “true” sortable (true|false)
“false”>
<!ELEMENT DefaultValue (#PCDATA)>
<!ELEMENT MinValue (#PCDATA)>
<!ELEMENT MaxValue (#PCDATA)>
<!ELEMENT EnumeratedValue (#PCDATA)>
<!ELEMENT ForcedValue (#PCDATA)>
```

The following explanations comment on each field in the above source code.

Schema: The root element for a schema description file that defines the structural representation for native application. Every schema description XML file that specifies this file as the DTD must have the Schema element as the root element.

Contents: StructureTemplate defines the organizational StructureTemplate of the schema description. The schema contains zero or more of these StructureTemplates.

Attributes: name. The name of this schema. It is used to distinguish the tables of this schema from those in another schema.

SchemaType: Defines the variation of schema, which translates to the prefix of the table names for each StructureTemplate within the schema. The SchemaType has a name attribute which is enumerated with allowable values of Current, Persistent or Requested.

Contents: none.

Attributes: name. The name of this schema type. Allowable values are Current, Persistent or Requested StructureTemplate Defines a collection of related properties. This is used to specify the format of a table in the relational database.

Contents: StructureName. The name of the SchemaStructure. It is used as the table name in the database. PrimaryKey Uniquely identifies each row in a relational database table. Property Defines an individual column in the table. There may be zero or more of these elements. Relation A mapping between the SchemaStructure where it is defined and another SchemaStructure. There may be zero or more of these elements. StructureRef a link to a sub-structure that may appear inside the StructureTemplate element where it is defined. this allows duplicate definitions to be avoided in a schema definition. StructureTemplate Sub-StructureTemplates that may appear inside the StructureTemplate element where it is defined.

Attributes: parentRelationType. Type of base StructureTemplate of which this StructureTemplate is a derived version.

StructureName: The name of a StructureTemplate. The value is specified using parsed character data. The Optional schemaName attribute, when defined, identifies the schema in which the corresponding StructureTemplate, identified by StructureName, is defined.

SchemaName: The name of the schema in which the StructureTemplate in the ForeignKey is defined. The value is specified using parsed character data.

PrimaryKey: A unique identifier for a given instance of an object/row in a database table.

Contents: Property. The actual value that is used as the unique identifier for the object/row in the database table. There are one or more of them in the primary key. Each one will result in a column in the database.

Relation: Defines how two tables, usually different, are associated.

Contents: ForeignKey. Refers to an instance of an object in a, usually different, table. ForeignKeyTemplate A description of the format that a foreign key must follow.

Attributes: name. The name of this relation. It is used as the column name in the database table. cardinality Specifies how many instances of the object in which the relation is specified are related to a given instance of the objects specified in the relation. There are four allowed values: one-to-one, zero-one-to-one, many-to-one and zero-many-to-one. Cardinality of one-to-one means that only one instance of the StructureTemplate in which the relation is specified is related to a given instance of the StructureTemplate identified by the relation, and the relation must occur. Cardinality of many-to-one means that one or more instance of the StructureTemplate in which the relation is specified is related to a given instance of the StructureTemplate, and the relation must occur. The ‘zero-’ variations of cardinality specify that the relation is optional. Thus, when the foreign keys are mapped into columns in the database table, the ‘zero-’ variations will allow NULL values in the columns, but the one-to-one and many-to-one will not allow NULL values.

Direction: Direction can have values of ‘up’ or ‘down’. Down indicates that the relation points from the Structure to a sub-Structure. Up indicates from sub-Structure to its parent Structure.

Maximum: If cardinality is many-to-one or zero-many-to-one, this specifies the maximum number of instances in the ‘many’ side of the relation that can be related to a given instance of the ‘one’ side of the relation. Optional. StructureRef acts as a place holder for the StructureTemplate specified by StructureName. this allows duplicate definitions to be avoided in a schema description. an analogy would be a C preprocessor macro. it may be used in multiple places, but is defined in a single place. if the definition is changed, the modification is propagated to all uses.

Contents: StructureName. The name of the table this key references. For each primary key column in the specified table, a column in the table where the foreign key is defined is created.

ForeignKey: Refers to an instance of an object in the specified table.

Contents: StructureName. The name of the table this key references. For each primary key column in the specified table, a column in the table where the foreign key is defined is created.

ForeignKeyTemplate. Defines the structure of a ForeignKey to use when the actual sub-structure is not known. All sub-structures must have primary keys in the specified format.

Contents: StructureNameTemplate. A placeholder for a structure name in the relation containing this ForeignKeyTemplate.

Attributes: relationType. Specifies the base type for a base class—derived class relationship. All derived class StructureTemplates must have the same value in the parentRelationType attribute.

StructureNameTemplate: A placeholder for a structure name in a relation. A column will be created in the table of the StructureTemplate that contains the relation in which the ForeignKeyTemplate is defined. The column will contain the StructureName (table name) values of the derived classes (StructureTemplates) of the base class (StructureTemplate) in which the relation is defined. Valid StructureTemplate, names will be determined by the parentRelationType attribute value in all derived structures having the same value as the relationType attribute in the ForeignKeyTemplate.

Attributes: name. name for the group of structures to which the ForeignKeyTemplate can refer.

PropertyTemplate: A generalized single attribute. Usually used in describing the format of other objects. Attributes: name A name to identify this property by (SourceMac, Gap). type Specifies the kinds of values the property may have. count The number of ‘type’ objects contained in this property. visible Whether this property should be shown to end users.

Property: A generalized single attribute.

Contents: EnumeratedValue. A list of the values the property may hold. MinValue The optional minimum value the property may hold. MaxValue The optional maximum value the property may hold. ForcedValue The value that a property is forced to. DefaultValue The optional default value of the property.

Attributes: name. A name to identify this property by (SourceMac, Gap). type Specifies the kinds of values the property may have. count The number of type objects contained in this property. visible Whether this property should be shown to end users. sortable Whether this property will be used to sort instances of structures containing this property—the database table for structures containing this property will have an index created for the column corresponding to this property if the sortable value is true.

DefaultValue: The value assigned to a property if no other is specified. The value is specified using parsed character data.

MinValue: The minimum value a property may have. The value is specified using parsed character data.

MaxValue: The maximum value a property may have. The value is specified using parsed character data.

EnumeratedValue: The values which may be assigned to a property. The value is specified using parsed character data.

ForcedValue: A value assigned to a property by TestCenter. This value supersedes all other values. UIs and TestCenter must prevent this value from being altered.

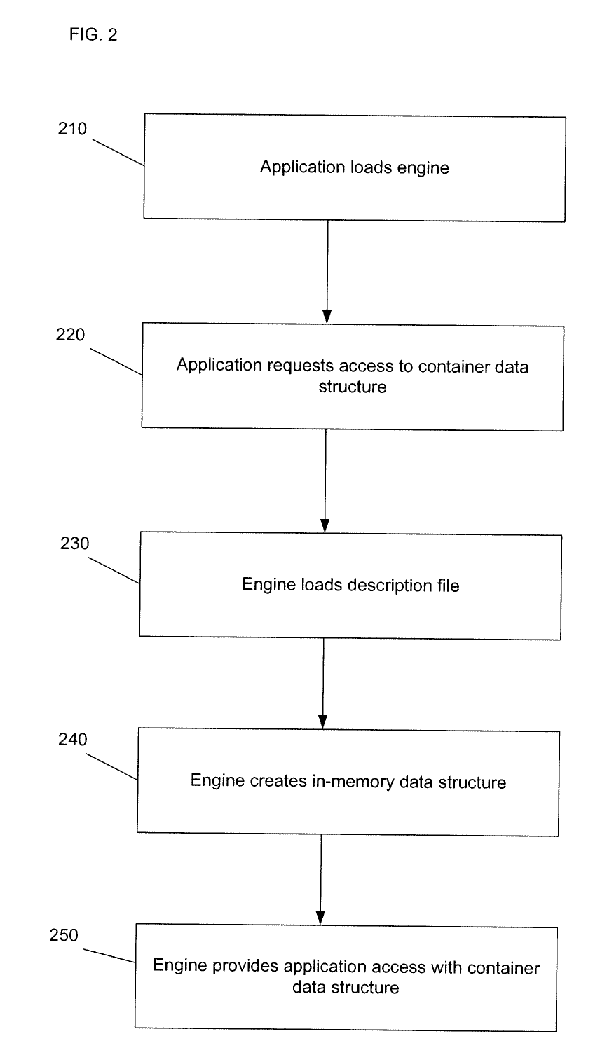

FIG. 2 is a flowchart illustrating steps involved in utilizing container data structures in accordance with embodiments of the invention. At step 210, a typical computer application embodying the invention (e.g., 150) loads a container data structure engine. The engine is comprised of a set of tools that may be independently loaded from one or more library files or accessed through a socket (e.g., remote procedure calls). The engine may also be a stand-alone or embedded application that may communicate with the rest of the application's components. The application typically implements a set of (or a the whole) application programming interface 130, that allows the application to communicate with the engine.

At step 220, the application requests access to the data. The request may be issued following the application process of loading external data, or creating in-memory representation of data structure for further use. The application may issue a request to access data structures following a user's input to create one or more data objects. In embodiments of the invention, the application may have one or more separate processes running simultaneously.

In embodiments of the invention, each component of the application issuing a request to access data, also provides a handle (e.g., an identifier or an address to the component) that may be utilized by the engine's components to communicate back to the application's components. For example, an application component may access a data structure and needs to be notified if and when the data has been modified (e.g., by a different component). The application component passes to the engine a handle that enables the engine to call a specific procedure in the application component. In the framework of object oriented programming, the component may implement a listener, and the handle to the listener is passed to the engine broadcast component to notify the listener when and if a datum is modified.

At step 230, the engine loads the container data structure description files. The latter step involves loading one or more description files, parsing the description, conducting several syntactic and logical checks, and translating one or more container data structures into one or more in-memory representations of data structures. At step 240, the engine creates the in-memory representation of one or more data structures. The memory is allocated to each structure based on the properties and hierarchical descriptions. At step 250, the engine provides application components access to the data structures by returning the output of specialized functions for handling input and output to each of the properties.

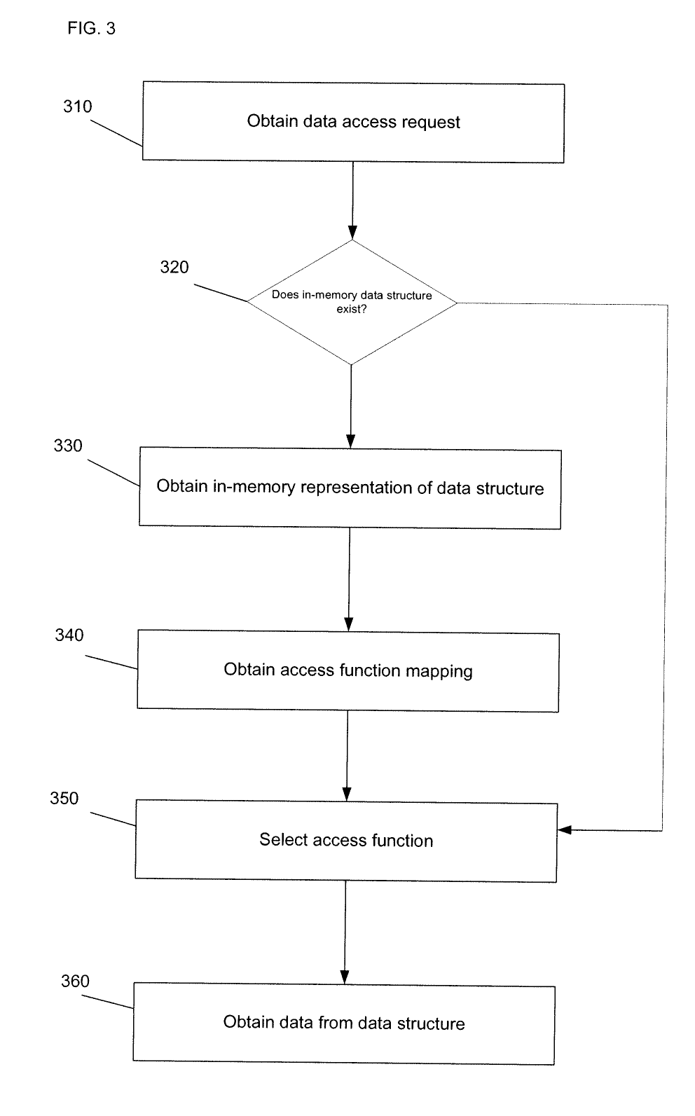

FIG. 3 is a flowchart illustrating steps involved in loading and handling data input and output request in applications embodying the invention. At step 310, a system embodying the invention obtains a request for data access. The request may be any type of data access. An application may require the creation of a new in-memory representation of one or more data structures. An application may request access to a data structure of part thereof, or an application may require access to modify a data values previously retrieved. At step 320, a system embodying the invention checks whether a data structure to be accessed in available in memory. If the data is not available in memory, the system proceeds to check whether an in-memory data structure is to created. At step 330, the system obtains an in-memory representation of one or more data structures. The latter step involves loading description files, parsing the description files (e.g. using an Extensible Markup Language parser), analyzing the hierarchical structure for each container data structure, allocating memory for each component of the in-memory representation, and storing the location reference of each component to be accessed to retrieve and modify data. At step 340, a system embodying the invention obtains a mapping for each data component to one or more functions for accessing and handling the data. For example, if a data has a property of an integer number, thus allowing only numeric characters and no floating point, the system associates one or more functions to check the integrity of the values. The latter functions may handle checking that the value of a datum is within a valid range, triggering an error message and selecting the target process to report error message, and perform all data handling necessary to store, retrieve and modify the data. At step 350, in the case of a request to access data, the system selects the access functions previously associated with data and makes a call to the said function. At step 360, the system accesses the data structure to obtain the data requested by an application component. At the latter step (step 360), the system also performs one or more steps for validating data dependencies and permissions. The engine is designed to handle a locking mechanism for handling access to different parts of any data structure. The engine may keep a list of application components that have accessed a data and provide read and/or write access to other application components. In embodiments of the invention, applications are written in object oriented programming languages and the functions are implemented using a synchronization mechanism, thus allowing only one function at a time to modify the data, while access requests from other components are queued to be handled serially.

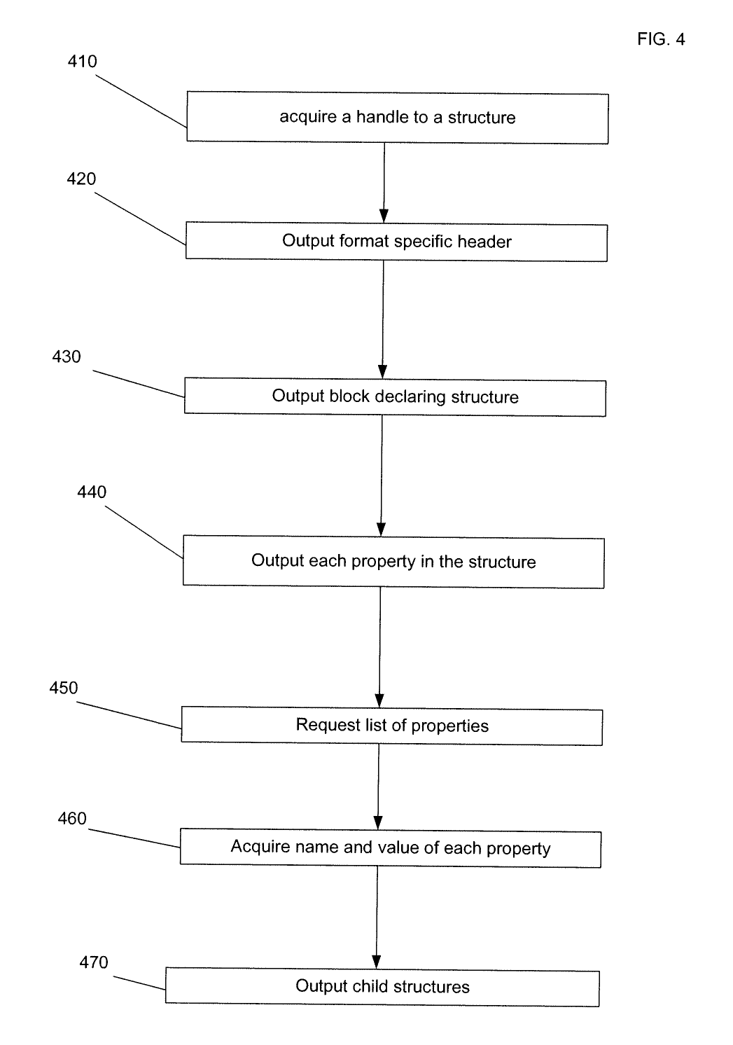

FIG. 4 shows the general procedure for exporting a self-describing data structure. The export/import module 160 acquires a handle to a structure (Step 410). The export/import module 160 outputs a format specific header (Step 420). The export/import module then outputs a block declaring the structure by asking the structure for its type and writing it using format-specific syntax (Step 430). Each property in the structure is then output with the property name and value written as strings (Step 440). Next, the list of properties is requested from the structure (Step 450). The export/import module 160 then acquires the name and value for each property which are written using a format-specific syntax (Step 460). Next, the export/import module 160 outputs the child structures (Step 470). According to one embodiment, for a format that allows the nesting of elements, the child structures are contained within the parent element.

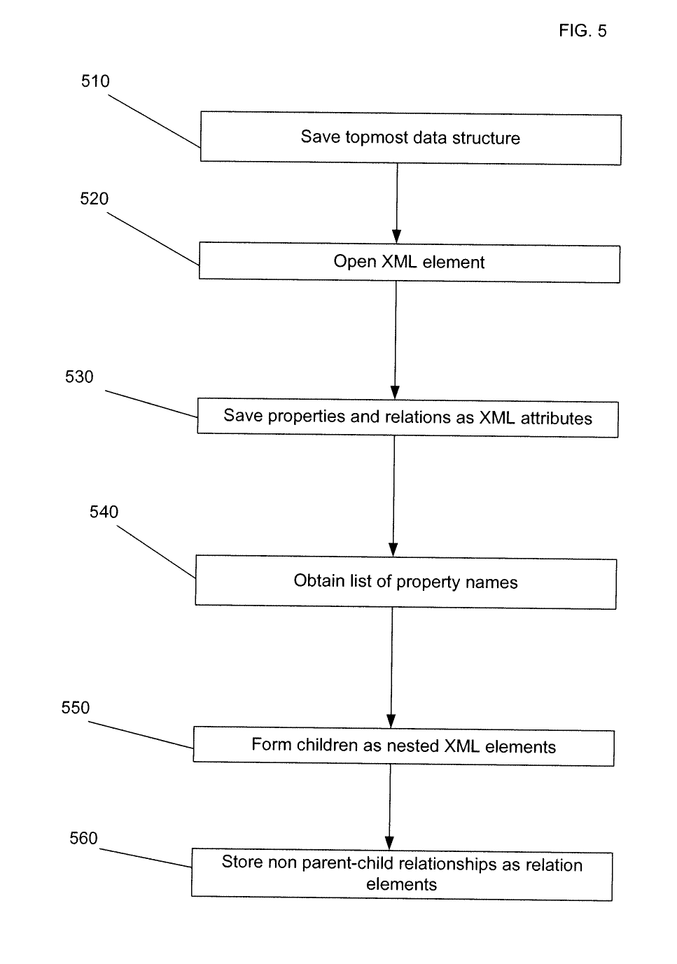

According to one embodiment and as shown in FIG. 5, the export/import module 160 can export the self-describing data structure to an XML format. According to one embodiment, the export/import module 160 creates one XML element per object in the data structure. First, the topmost data structure in the hierarchy of structures is saved (Step 510). Its XML element is opened using the data structure's name as the name of the element (Step 520). The elements are named using the class name for each object. The export/import module 160 creates one XML attribute for each property in the data structure. Its properties and relations are saved as XML attributes (Step 530). The XML attribute name is equal to the name learned from the self-describing data structure. The list of property names is obtained from the data structure (Step 540). The value of the XML attribute is equal to the string version of the property value obtained from the data structure.

The data structure's children are implemented as nested XML elements under the parent (Step 550). According to one embodiment, once the list of child objects is determined from the data model, the export/import module nests each XML element in a parent XML element corresponding to a child object in the data model under its parent object in the data model. Relationships from the data structure other than parent-child relationships are stored as Relation elements within one of the relatives, using an identifier appearing in both the Relation element and the other relative's element (Step 560). According to one embodiment, the export/import module 160 marks XML elements with an “id” attribute and references that id and the relation type from a related object using a Relation sub-element within the relative. The Relation sub-element specifies the identifier of the relative in either a “source” or “target: element, and the type of relation.

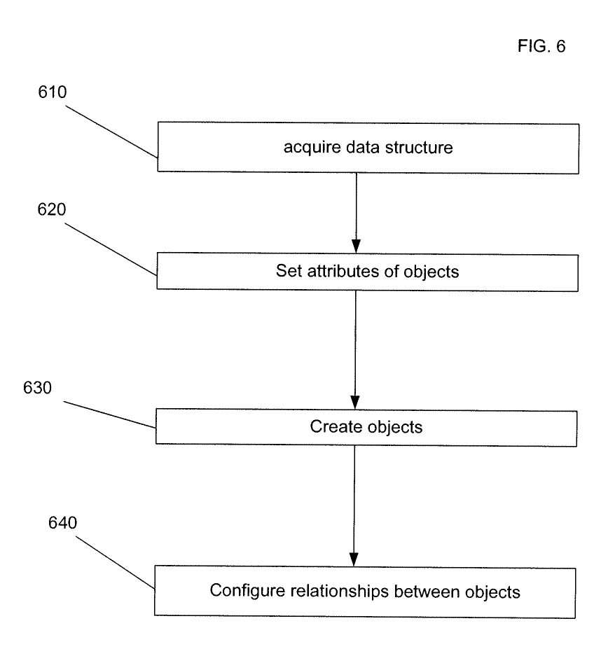

According to one embodiment and as shown in FIG. 6, the export/import module 160 can export the self-describing data structure to a Tcl file format. To export the self-describing data structure as Tcl, a main script is first saved that loads the second “logic” script and invokes the procedures defined in that logic script. The logic script is saved using the following procedures:
init: Initializes the system and self-describing data structure library.
config: Creates all of the data structures and sets their property values.
connect: Establishes a connection to hardware listed in the configuration.
apply: Sends the configuration defined in the config procedure to the connected hardware.
run: Executes the sequence of commands from the configuration.
disconnect: Tears down connections established in the connect procedure.

Once generated, the main Tcl script can be executed to recreate the configuration and execute or restore the included sequence of test commands, test configurations and test sequences. Starting from a provided node, elements of the data structure are recursively processed. Using class names determined from the data structure (Step 610), the export/import module 160 is configured to write out statements to create objects (Step 630). The export/import module 160 sets the attributes of the objects by first determining the name and value of the attributes from the data structure and then including the name/value pairs in the call to create objects (Step 620). According to another embodiment, returned object handles can be stored as uniquely-named variables. According to another embodiment, the export/import module 160 can configure relationships between objects, including parent/child relationships as well as other relationships, by setting the relationships using the relationship type name learned from the data model and the variables containing handles of the related structures (Step 640).

According to one embodiment, the export/import module 160 is configured to output standard initialization logic, e.g., connect to hardware listed in the data structures. According to one embodiment, the export/import module 160 can then send a configuration such as a test configuration to the connected hardware. According to another embodiment, the export/import module 160 can invoke a sequence of commands present in the data structure. According to another embodiment, the export/import module 160 can output standard shutdown logic such as disconnecting from hardware listed in the data structures. The executable script that is generated from the self-describing data structure can be used to restore and execute a test configuration and test sequence.

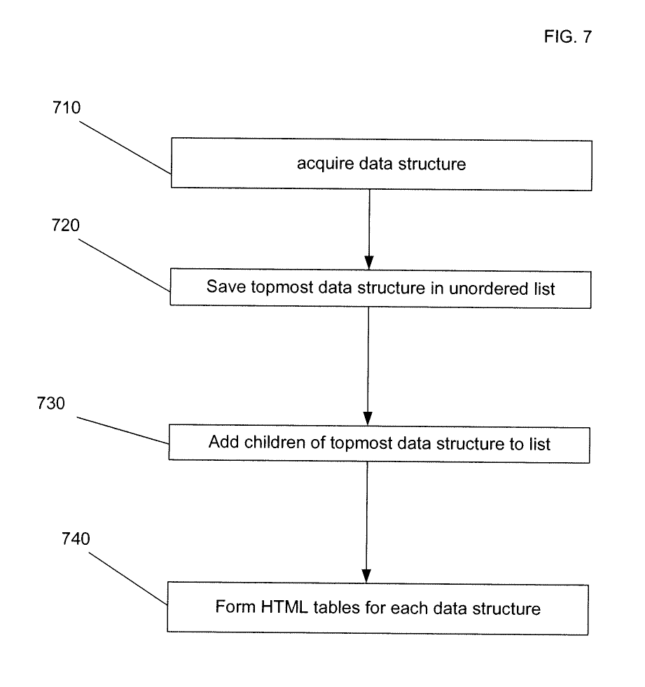

According to one embodiment and as shown in FIG. 7, the export/import module 160 can export the self-describing data structure to a HTML export file format. The export/import module 160 creates one HTML header per object in the data structure. The header text includes the name and type of data structure object. First the data structure is acquired (Step 710). To generate HTML, the topmost data structure in the hierarchy of structures is saved as the first list element in an unordered list (Step 720). Next, its children are added as a nested list, and so on recursively to form a tree corresponding to the parent/child relationships in the self-describing data structure (Step 730). Each entry in the tree includes the name of the data structure and a link to a named anchor containing the full data structure information. Each list item would contain the name of an object from the data model, linked to the object's HTML table. Children of the object would be listed in an unordered list below the list item element for the parent. After the tree the HTML tables for the data structures are saved (Step 740). Each data structure has one table, each with two columns, one for names and one for values). One row is created for each property in the data structure object, with the name for the property being placed in the first column and the value in the second. Each data structure's properties are queried and the resulting list of name/value pairs is used to create the rows in the table.

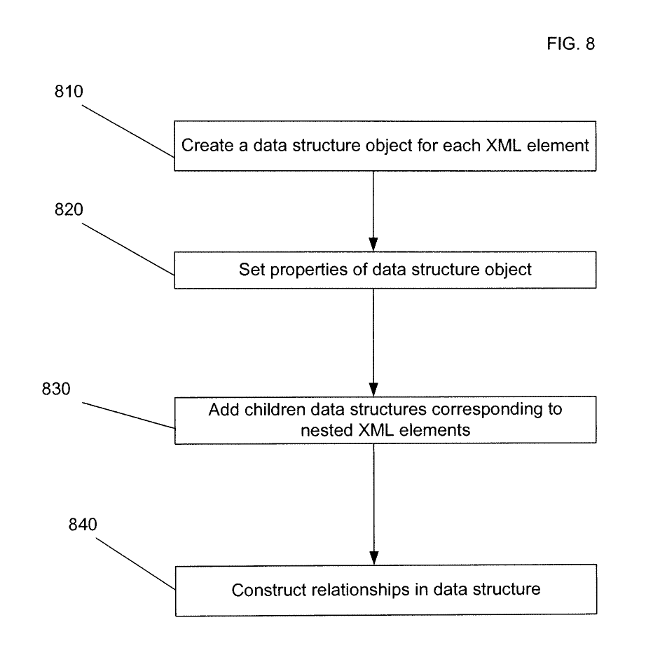

According to one embodiment and as shown in FIG. 8, the export/import module 160 can import a self-describing data structure into the description files 110 from a XML file format. The export/import module 160 creates a data structure object for each XML element using the element name as the type of new object (Step 810). Next, the export/import module 160 sets the properties of the data structure object corresponding to the XML element using the XML attribute name as the property name and the XML attribute value as the property value (Step 820). Then, each new data structure object for a nested XML element is added as a child of a previously—created data structure object corresponding to the enclosing XML element (Step 830). Next the export/import module 160 constructs relationships in the data structure based on the Relation sub-elements for the data structure (Step 840). The “type” attribute of the Relation element specifies the type of the relationship to be created. The “target” or “source” attribute provides the unique identifier for the other end of the relationship, as well as specifying the direction of the relationship to be constructed in the data model. “target” indicates the relationship should have the object with the Relation element as the source and the object corresponding to the identifier as the target. “source” indicates the relationship should have the object with the Relation element as the target and the object corresponding to the identifier as the source.

As detailed above, the export/import module 160 has several advantages. The export/import module 160 is configured to read or write structures from a particular format for any type of schema/data model. Accordingly, custom code for reading or writing individual data structures for each new structure definition is not required.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs. The present invention also contemplates providing computer readable data storage means with program code recorded thereon (i.e., software) for implementing the method steps described earlier herein. Programming the method steps discussed herein using custom and packaged software is within the abilities of those skilled in the art in view of the teachings disclosed herein.

The foregoing description of a preferred embodiment of the invention has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. A method for constructing an alternate representation of a self-describing data structure, comprising:
executing a data structure engine and an export/import module in a computer system;
said export/import module obtaining at least one description set for at least one container data structure from said data structure engine;
creating a header for each element in the container data structure;
declaring the container data structure by writing its type in a format-specific syntax;
outputting each property in the container data structure; and
outputting child structures to form an external representation of the self-describing data structure.

2. The method of claim 1, wherein each property has a name and a value that are written as strings.

3. The method of claim 1, wherein for a format that allows elements to be nested, the child structures are contained within a parent element.

4. The method of claim 1, wherein the external representation is a XML file.

5. The method of claim 1, wherein the external representation is a Tcl script.

6. The method of claim 1, wherein the external representation is a HTML file.

7. A method for constructing a XML file from a self-describing data structure, comprising:
executing a data structure engine and an export/import module in a computer system;
said export/import module obtaining at least one description set for at least one container data structure from said data structure engine;
saving the topmost data structure in the hierarchy of the container data structure;
creating an XML element per object in the container data structure;
creating XML attributes for the properties of each object in the container data structure;
determining a list of child objects from the container data structure;
nesting each XML element in a parent XML element corresponding to the child objects; and
storing relationships from the container data structure as relation elements to form an XML file representation of the self-describing data structure.

8. The method of claim 7, wherein the XML elements are named the same as the class name for each corresponding object in the container data structure.

9. The method of claim 7, wherein for each XML attribute, its value is equal to the corresponding properties string value.

10. A method for constructing a Tcl script file from a self-describing data structure, comprising:
executing a data structure engine and an export/import module in a computer system;
said export/import module obtaining at least one description set for at least one container data structure from said data structure engine;
creating objects using class names acquired from the container data structure;
setting the attributes of the objects;
storing returned object handles as uniquely named variables; and
configuring relationships between the objects using a relationship type name acquired from the data model to form a Tcl script representing the self-describing data structure.

11. The method of claim 10, wherein the Tcl script representing the self describing data structure can be used for executing a test configuration and test sequence for hardware, comprising the steps of:
outputting standard initialization logic to connect to the hardware;
sending a configuration script in the form of the Tcl script to the connected hardware;
invoking a sequence of commands present in the container data structure using the Tcl script; and
disconnecting from the hardware.

12. A method for constructing a HTML file from a self-describing data structure, comprising:
executing a data structure engine and an export/import module in a computer system;
said export/import module obtaining at least one description set for at least one container data structure from said data structure engine;
creating an HTML header per object in the container data structure;
nesting unordered lists to create a tree corresponding to a parent/child relationship in the container data structure; and
creating one HTML table for the properties in each object in the container data structure to form a HTML file representing the self-describing data structure.

13. The method as claimed in claim 12, wherein text in the HTML header includes a name and type of the object in the container data structure.

14. The method of claim 12, wherein the HTML table has two columns, wherein the first column stores property names and the second column stores property values.

15. A method of importing an XML file into a self-describing data structure, comprising:
creating one data structure object for each XML element;
setting the properties of the data structure for each corresponding XML element using the XML attribute name as the property name and the XML attribute value as the property value;
adding a data structure object for each nested XML element as a child of a previously-created data structure object corresponding to the enclosing XML element; and
constructing relationships in the data structure based on relation sub-elements for the data structure.
